(19) United States
(12) Patent Application Publication
(10) Pub. No.: US 2025/0129272 A1
(43) Pub. Date: Apr. 24, 2025

(54) BIODEGRADABLE LAMINATING FILM

(71) Applicant: BASF SE, Ludwigshafen am Rhein (DE)

(72) Inventors: Michael Bernhard SCHICK, Ludwigshafen am Rhein (DE); Jerome LOHMANN, Ludwigshafen am Rhein (DE); Timo Benjamin WITT, Ludwigshafen am Rhein (DE); Frank BLOSS, Ludwigshafen am Rhein (DE)

(21) Appl. No.: 18/695,857

(22) PCT Filed: Sep. 27, 2022
(86) PCT No.: PCT/EP2022/076843

§ 371 Date: Mar. 27, 2024

(30) Foreign Application Priority Data
Sep. 28, 2021 (EP) 21199555.0

(51) Int. Cl. C09J 7/29; C09J 133/08; C09J 175/04

(52) U.S. Cl. CPC C09J 7/29; C09J 133/08; C09J 175/04; C09J 2301/416; C09J 2301/50

(57) ABSTRACT

The present invention relates to a biodegradable lamination film having the A/B layer structure, where layer A of thickness 0.5 to 7 μm comprises a polyurethane or acrylate adhesive; and where layer B of thickness 5 to 150 μm comprises an aliphatic polyester and/or aliphatic-aromatic polyester, where the aliphatic-aromatic polyester is of the following composition:
b1-i) 30 to 70 mol %, based on components b1-i and b1-ii, of a C₆-C₁₈ dicarboxylic acid;
b1-ii) 30 to 70 mol %, based on components b1-i and b1-ii, of terephthalic acid;
b1-iii) 98 to 100 mol %, based on components b1-i and b1-ii, of propane-1,3-diol or butane-1,4-diol;
b1-iv) 0% to 2% by weight, based on components b1-i and b1-iii, of a chain extender and/or branching agent.

The present invention relates to a biodegradable lamination film having the A/B layer structure, where layer A of thickness 0.5 to 7 μm comprises a polyurethane or acrylate adhesive; and where layer B of thickness 5 to 150 μm comprises an aliphatic polyester and/or aliphatic-aromatic polyester, where the aliphatic-aromatic polyester is of the following composition:
b1-i) 30 to 70 mol %, based on components b1-i and b1-ii, of a C₆-C₁₈ dicarboxylic acid;
b1-ii) 30 to 70 mol %, based on components b1-i and b1-ii, of terephthalic acid;
b1-iii) 98 to 100 mol %, based on components b1-i and b1-ii, of propane-1,3-diol or butane-1,4-diol;
b1-iv) 0% to 2% by weight, based on components b1-i and b1-iii, of a chain extender and/or branching agent.

The invention further relates to the use of the abovementioned lamination film for coating of substrates such as paper or board in particular, and to a process for producing a composite film, wherein the abovementioned lamination film is pressed onto a substrate.

Flexible packagings are used in the food and drink industry in particular. They frequently consist of composite films that are bonded together by a suitable adhesive, where at least one of the mutually bonded films is a polymer film. There is a high demand for biodegradable composite film packaging that can be disposed of by composting after use.

Various approaches have been followed to date in the literature:

WO 2010/034712 describes a process for extrusion coating of paper with biodegradable polymers. In this process, generally no adhesives are used. The coated papers obtainable by the process described in WO 2010/034712 are not suitable for every application because of limited adhesion to the paper, mechanical properties, barrier properties and biodegradation of the paper composite.

WO 2012/013506 describes the use of an aqueous polyurethane dispersion adhesive for production of composite films that are industrially compostable to some degree. Degradation in industrial composting plants takes place under high humidity, in the presence of particular microorganisms and at temperatures of about 55° C. There are constantly rising demands on flexible packaging with regard to its biodegradability, and so home compostability is now frequently a requirement for numerous applications. The composite films described in WO 2012/013506 do not sufficiently meet this criterion and are also not suitable for all applications of flexible packaging with regard to their mechanical properties and barrier properties.

The aim of the present invention was therefore that of providing lamination films that are improved with regard to their biodegradability, are preferably home-compostable, have good adhesion to the substrate, preferably to the paper, and also meet the other demands on modern flexible packaging.

These criteria are surprisingly met by the lamination films described at the outset.

The invention is more particularly described hereinbelow.

Layer A may also be referred to as adhesive layer and establishes the bonding of layer B to the substrate. Layer A has a layer thickness of 0.5 to 7 μm and comprises a polyurethane or acrylate adhesive.

The adhesive in layer A preferably consists essentially of at least one water-dispersed polyurethane as polymeric binder and optionally additives such as fillers, thickeners, defoamers, etc., as described in detail in WO 2012/013506. The essential features of the polyurethane adhesive described in WO 2012/013506, to which reference is made explicitly, are detailed below:

The polymeric binder preferably takes the form of a dispersion in water or else in a mixture of water and water-soluble organic solvents having boiling points of preferably below 150° C. (1 bar). Particular preference is given to water as the sole solvent. Weight figures relating to the composition of the adhesive do not include water or other solvents.

The polyurethane dispersion adhesive is preferably biodegradable. Biodegradability in the context of this application is considered to exist, for example, when the ratio of gaseous carbon released in the form of CO₂ to the total carbon content of the material used after 20 days is at least 30%, preferably at least 60% or at least 80%, measured according to standard ISO 14855 (2005).

The polyurethanes preferably consist predominantly of polyisocyanates, especially diisocyanates, on the one hand and, as coreactants, polyester diols and bifunctional carboxylic acids on the other hand. The polyurethane is preferably formed to an extent of at least 40% by weight, more preferably to an extent of at least 60% by weight and most preferably to an extent of at least 80% by weight of diisocyanates, polyester diols and bifunctional carboxylic acids.

The polyurethane may be amorphous or semicrystalline. When the polyurethane is semicrystalline, its melting point is preferably less than 80° C. For this purpose, the polyurethane preferably comprises polyester diols in an amount of more than 10% by weight, more than 50% by weight or at least 80% by weight, based on the polyurethane. The BASF SE polyurethane dispersions sold under the Epotal® trade name are particularly suitable.

Overall, the polyurethane is preferably formed from:
a) diisocyanates,
b) diols, of which
b1) 10 to 100 mol %, based on the total amount of the diols (b), are polyester diols and have a molecular weight of 500 to 5000 g/mol,
b2) 0 to 90 mol %, based on the total amount of the diols (b), have a molecular weight of 60 to 500 g/mol,
c) at least one bifunctional carboxylic acid selected from dihydroxycarboxylic acids and diaminocarboxylic acids,
d) optionally further polyfunctional compounds different from monomers (a) to (c) and having reactive groups that are alcoholic hydroxyl groups, primary or secondary amino groups or isocyanate groups, and
e) optionally monofunctional compounds different from monomers (a) to (d) and having a reactive group that is an alcoholic hydroxyl group, a primary or secondary amino group or an isocyanate group.

A home-compostable adhesive in layer A as described in PCT/EP2021/054570, published as WO 2021/175676 A1, is especially preferable. The essential features of the polyurethane adhesive described PCT/EP2021/054570, to which reference is made explicitly here, are detailed below:

The aqueous polyurethane dispersion adhesives of PCT/EP2021/054570 are suitable for production of composite films that are biodegradable under home composting conditions (25±5° C.), wherein at least one layer B and a second substrate are bonded using the polyurethane dispersion adhesive A, and
wherein at least one of the substrates is a polymer film which is biodegradable under home composting conditions, and wherein at least 60% by weight of the polyurethane consists of:
(a) at least one diisocyanate
(b) at least one polyester diol, and
(c) at least one bifunctional carboxylic acid selected from dihydroxycarboxylic acids and diaminocarboxylic acids;
wherein the polyurethane has a glass transition temperature below 20° C. and either does not have a melting point above 20° C. or has a melting point above 20° C. with an enthalpy of fusion of less than 10 J/g, and
wherein layer A of the polyurethane adhesive preferably breaks down under home composting conditions to an extent of more than 90% by weight to CO₂ and water within 360 days; and wherein layer A of the polyurethane adhesive is preferably home-compostable, and
wherein the lamination film A/B produced therefrom is preferably biodegradable under home composting conditions when there is not more than 10% of the original dry weight of the material after aerobic composting at 25±5° C. over a period of not more than 180 days in a >2 mm sieve fraction.

A film composed of the polyurethane adhesive, layer B and/or the substrate and/or the composite film is preferably home-compostable.

The BASF SE polyurethane dispersions sold under the Epotal® Eco trade name are especially suitable.

Layer B of the invention has a layer thickness of 5 to 150 μm and comprises an aliphatic polyester and/or aliphatic-aromatic polyester, wherein the aliphatic-aromatic polyester is of the following composition:
b1-i) 30 to 70 mol %, based on components b1-i and b1-ii, of a C₆-C₁₈ dicarboxylic acid;
b1-ii) 30 to 70 mol %, based on components b1-i and b1-ii, of terephthalic acid;
b1-iii) 98 to 100 mol %, based on components b1-i and b1-ii, of propane-1,3-diol or butane-1,4-diol;
b1-iv) 0% to 2% by weight, based on components b1-i and b1-iii, of a chain extender and/or branching agent.

Aliphatic polyester is understood to mean, for example, the polyesters described in detail in WO 2010/034711, to which reference is made here explicitly.

The polyesters of WO 2010/034711 (i) generally have the following construction:
i-a) 80 to 100 mol %, based on components i-a to i-b, of succinic acid;
i-b) 0 to 20 mol %, based on components i-a to i-b, of one or more C₆-C₂₀ dicarboxylic acids;
i-c) 99 to 102 mol %, preferably 99 to 100 mol %, based on components i-a to i-b, of propane-1,3-diol or butane-1,4-diol;
i-d) 0% to 1% by weight, based on components i-a to i-c, of a chain extender or branching agent.

The polyesters i of WO 2010/034711 are preferably synthesized in a direct polycondensation reaction of the individual components. The dicarboxylic acid derivatives are converted together with the diol in the presence of a transesterification catalyst directly to the polycondensate of high molecular weight. On the other hand, a copolyester can also be obtained by transesterification of polybutylene succinate (PBS) with C₆-C₂₀ dicarboxylic acids in the presence of diol. Catalysts used are typically zinc catalysts, aluminum catalysts and especially titanium catalysts. Titanium catalysts such as tetraisopropyl orthotitanate and especially tetraisobutoxytitanate (TBOT) have the advantage over the tin, antimony, cobalt and lead catalysts frequently used in the literature, for example tin dioctanoate, that residual amounts of the catalyst or conversion product of the catalyst remaining in the product are less toxic. This fact is particularly important in the case of biodegradable polyesters, since they get directly into the environment.

The polyesters mentioned can additionally be produced by the processes described in JP 2008-45117 and EP-A 488 617. It has been been found to be advantageous first to convert components a to c to a prepolyester having a VN of 50 to 100 ml/g, preferably 60 to 80 ml/g, and then to react said prepolyester with a chain extender i-d, for example with diisocyanates or with epoxy-containing polymethacrylates, in a chain extension reaction to give a polyester i having a VN of 100 to 450 ml/g, preferably 150 to 300 ml/g.

The acid component i-a used is 80 to 100 mol %, based on the acid components a and b, preferably 90 to 99 mol % and especially preferably 92 to 98 mol % of succinic acid. Succinic acid is obtainable by a petrochemical route, and also preferably from renewable raw materials as described, for example, in EPA 2185682. EPA 2185682 discloses a biotechnological method of producing succinic acid and butane-1,4-diol proceeding from different carbohydrates with microorganisms from the class of the Pasteurellaceae.

Acid component i-b is used in 0 to 20 mol %, preferably 1 to 10 mol % and especially preferably 2 to 8 mol % based on the acid components i-a and i-b.

C₆-C₂₀ dicarboxylic acids i-b are understood to mean in particular adipic acid, suberic acid, azelaic acid, sebacic acid, brassylic acid and/or C₁₈ dicarboxylic acid. Preference is given to suberic acid, azelaic acid, sebacic acid and/or brassylic acid. The abovementioned acids are obtainable from renewable raw materials. For example, sebacic acid is obtainable from castor oil. Such polyesters feature excellent biodegradation characteristics [literature: Polym. Degr. Stab. 2004, 85, 855-863].

The dicarboxylic acids i-a and i-b may be used either as free acids or in the form of ester-forming derivatives. Ester-forming derivatives include in particular the di-C₁— to C₆-alkyl esters, such as dimethyl, diethyl, di-n-propyl, diisopropyl, di-n-butyl, diisobutyl, di-t-butyl, di-n-pentyl, diisopentyl or di-n-hexyl esters. Anhydrides of the dicarboxylic acids may likewise be used. It is possible here to use the dicarboxylic acids or their ester-forming derivatives individually or as a mixture.

The diols propane-1,3-diol and butane-1,4-diol are likewise obtainable from renewable raw materials. It is also possible to use mixtures of the two diols. Because of the higher melting temperatures and better crystallization of the copolymer formed, butane-1,4-diol is preferred as the diol.

In general, on commencement of the polymerization, the diol (component i-c) is set relative to the acids (components i-a and i-b) in a ratio of diol to diacids of 1.0:1 to 2.5:1 and preferably 1.3:1 to 2.2:1. Excess amounts of diol are drawn off during the polymerization, and so an approximately equimolar ratio is established at the end of the polymerization. Approximately equimolar is understood to mean a diacid/diol ratio of 0.98 to 1.00.

In one embodiment, 0% to 1% by weight, preferably 0.1% to 0.9% by weight and especially preferably 0.1% to 0.8% by weight, based on the total weight of components i-a to i-b, of a branching agent i-d and/or chain extender i-d′ selected from the group consisting of: a polyfunctional isocyanate, isocyanurate, oxazoline, carboxylic anhydride such as maleic anhydride, epoxide (especially an epoxy-containing poly (meth) acrylate), an at least trifunctional alcohol or an at least trifunctional carboxylic acid is used. In general, no branching agents and only chain extenders are used.

Suitable bifunctional chain extenders are understood to be, for example, tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate or xylylene diisocyanate, hexamethylene 1,6-diisocyanate, isophorone diisocyanate or methylenebis (4-isocyanatocyclohexane). Particular preference is given to isophorone diisocyanate and especially hexamethylene 1,6-diisocyanate.

Aliphatic polyesters i are understood to mean in particular polyesters such as polybutylene succinate (PBS), polybutylene succinate-co-adipate (PBSA), polybutylene succinate-co-sebacate (PBSSe), polybutylene succinate-co-azelate (PBSAz) or polybutylene succinate-co-brassylate (PBSBr). The aliphatic polyesters PBS and PBSA are marketed, for example, by Mitsubishi under the BioPBS® name. More recent developments are described in WO 2010/034711.

The polyesters i generally have a number-average molecular weight (Mn) in the range from 5000 to 100 000, in particular in the range from 10 000 to 75 000 g/mol, preferably in the range from 15 000 to 50 000 g/mol, a weight-average molecular weight (Mw) of 30 000 to 300 000, preferably 60 000 to 200 000 g/mol, and an Mw/Mn ratio of 1 to 6, preferably 2 to 4. The viscosity number is between 30 and 450, preferably from 100 to 400 g/ml (measured in o-dichlorobenzene/phenol (50/50 weight ratio)). The melting point is in the range from 85° C. to 130° C., preferably in the range from 95° C. to 120° C. The MVR range according to DIN EN 1133-1 is in the range from 8 to 50 and especially 15 to 40 cm³/10 min (190° C., 2.16 kg).

Among aliphatic polyesters for layer B, polyhydroxyalkanoates such as polycaprolactone (PCL), poly-3-hydroxybutyrate (PHB), poly-3-hydroxybutyrate-co-3-hydroxyvalerate (P(3HB)-co-P(3HV)), poly-3-hydroxybutyrate-co-4-hydroxybutyrate (P(3HB)-co-P(4HB)) and poly-3-hydroxybutyrate-co-3-hydroxyhexanoate (P(3HB)-co-P(3HH)) and especially polylactic acid (PLA) are also used.

Preference is given to using polylactic acid b2 with the following profile of properties:
a melt volume flow rate (MVR at 190° C. and 2.16 kg according to ISO 1133-1 DE of 0.5 to 100
and in particular from 5 to 50 cm³/10 minutes)
a melting point below 240° C.;
a glass transition temperature (Tg) greater than 55° C.
a water content of less than 1000 ppm
a residual monomer content (lactide) of less than 0.3%
a molecular weight of greater than 80 000 daltons.

Preferred polylactic acids are crystalline polylactic acid grades from NatureWorks, for example Ingeo® 6201 D, 6202 D, 6251 D, 3051 D, and 3251 D, and especially 4043 D and 4044 D, and polylactic acids from Total Corbion, for example Luminy® L175 and LX175 Corbion, and polylactic acids from Hisun such as Revode® 190 or 110. But amorphous polylactic acid grades may also be suitable, for example Ingeo® 4060 D from NatureWorks.

Aliphatic-aromatic polyesters b1 in layer B are to be understood to mean linear, chain-extended and optionally branched and chain-extended polyesters, as described for example in WO 96/15173 to 15176 or in WO 98/12242, which are explicitly incorporated by reference. Mixtures of different semiaromatic polyesters are likewise useful. Recent developments of interest are based on renewable raw materials (see WO 2010/034689). In particular, polyesters b1 are to be understood to mean products such as ecoflex® (BASF SE).

Preferred polyesters b1 include polyesters comprising as essential components:
b1-i) 30 to 70 mol %, preferably 40 to 60 mol % and especially preferably 50 to 60 mol %, based on components b1-i) and b1-ii), of an aliphatic dicarboxylic acid or mixtures thereof, preferably as follows: adipic acid and especially azelaic acid, sebacic acid and brassylic acid,
b1-ii) 30 to 70 mol %, preferably 40 to 60 mol % and especially preferably 40 to 50 mol %, based on components b1-i) and b1-ii), of an aromatic dicarboxylic acid or mixtures thereof, preferably as follows: terephthalic acid,
b1-iii) 98 to 100 mol %, based on components b1-i) and b1-ii), of butane-1,4-diol and propane-1,3-diol; and
b1-iv) 0% to 2% by weight, preferably 0.1% to 1% by weight, based on components b1-i) to b1-iii) of a chain extender, in particular of a di-or polyfunctional isocyanate, preferably hexamethylene diisocyanate, and optionally of a branching agent, preferably: trimethylolpropane, pentaerythritol and in particular glycerol.

Useful aliphatic diacids and corresponding derivatives b1-i are generally those having 6 to 18 carbon atoms, preferably 9 to 14 carbon atoms. They may be either linear or branched.

Examples of these include: adipic acid, azelaic acid, sebacic acid, brassylic acid and suberic acid. It is possible here to use the dicarboxylic acids or their ester-forming derivatives individually or as a mixture of two or more thereof.

Preference is given to using adipic acid, azelaic acid, sebacic acid, brassylic acid or their respective ester-forming derivatives or mixtures thereof. Particular preference is given to using azelaic acid or sebacic acid or their respective ester-forming derivatives or mixtures thereof.

Preference is given especially to the following aliphatic-aromatic polyesters: polybutylene adipate-co-terephthalate (PBAT), polybutylene adipate-co-azaterephthalate (PBAAZT), polybutylene adipate-co-sebacate terephthalate (PBASeT), polybutylene azelate-co-terephthalate (PBAzT) and polybutylene sebacate-co-terephthalate (PBSeT), and mixtures of these polyesters.

Owing to better home compostability according to Australian standard AS 5810-2010 and ISO 14855-1 (2012), particular preference is given to polybutylene adipate-co-azaterephthalate (PBAAzT), polybutylene adipate-co-sebacate terephthalate (PBASeT), polybutylene azelate-co-terephthalate (PBAzT) and polybutylene sebacate-co-terephthalate (PBSeT), and mixtures of polybutylene adipate-co-terephthalate (PBAT) with polybutylene azelate-co-terephthalate (PBAzT) and polybutylene sebacate-co-terephthalate (PBSeT).

The aromatic dicarboxylic acids or the ester-forming derivatives b1-ii thereof may be used individually or as a mixture of two or more thereof. Particular preference is given to using terephthalic acid or the ester-forming derivatives thereof such as dimethyl terephthalate.

The diols b1-iii—butane-1,4-diol and propane-1,3-diol—are obtainable as a renewable raw material. It is also possible to use mixtures of the diols mentioned.

In general, 0% to 1% by weight, preferably 0.1% to 1.0% by weight and especially preferably 0.1% to 0.3% by weight, based on the total weight of the polyester, of a branching agent and/or 0% to 1% by weight, preferably 0.1% to 1.0% by weight, based on the total weight of the polyester, of a chain extender (b1-vi) are used. The chain extender used is preferably a di- or polyfunctional isocyanate, preferably hexamethylene diisocyanate, and branching agents used are preferably polyols such as preferably trimethylolpropane, pentaerythritol and especially glycerol.

The polyesters b1 generally have a number-average molecular weight (Mn) in the range from 5000 to 100 000, in particular in the range from 10 000 to 75 000 g/mol, preferably in the range from 15 000 to 38 000 g/mol, a weight-average molecular weight (Mw) of 30 000 to 300 000 and preferably 60 000 to 200 000 g/mol, and an Mw/Mn ratio of 1 to 6, preferably 2 to 4. The viscosity number is between 50 and 450 and preferably from 80 to 250 g/ml (measured in o-dichlorobenzene/phenol (weight ratio 50/50)). The melting point is in the range from 85° C. to 150° C., preferably in the range from 95° C. to 140° C.

The MVR (melt volume flow rate) according to EN ISO 1133-1 DE (190° C., weight 2.16 kg) of polyester b1 is generally 0.5 to 20 cm³/10 min, preferably 5 to 15 cm³/10 min. The acid numbers according to DIN EN 12634 are generally 0.01 to 1.2 mg KOH/g, preferably 0.01 to 1.0 mg KOH/g and especially preferably 0.01 to 0.7 mg KOH/g.

In general, 0% to 25% by weight, in particular 3% to 20% by weight, based on the total weight of layer B, of at least one mineral filler b3 is used, selected from the group consisting of: chalk, graphite, gypsum, conductive carbon black, iron oxide, calcium sulfate, dolomite, kaolin, silicon dioxide (quartz), sodium carbonate, calcium carbonate, titanium dioxide, silicate, wollastonite, mica, montmorillonite and talc. Preferred mineral fillers are silicon dioxide, kaolin and calcium sulfate, and the following are especially preferred: calcium carbonate and talc.

A preferred embodiment of layer B comprises:
b1) 60% to 100% by weight, preferably 60% to 99.95% by weight, of an aliphatic-aromatic polyester selected from the group consisting of: polybutylene adipate-co-terephthalate, polybutylene azelate-co-terephthalate and polybutylene sebacate-co-terephthalate;
b2) 0% to 15% by weight, preferably 3% to 12% by weight, of a polyhydroxyalkanoate, preferably a polylactic acid;
b3) 0% to 25% by weight, preferably 3% to 20% by weight, of a mineral filler.

Layer B especially preferably additionally comprises
b4) 0.05% to 0.3% by weight of a lubricant selected from erucamide and stearamide.

In one embodiment, layer B does not comprise any lubricants or demolding agents. This embodiment has very good compatibility with layer A up to layer thicknesses of 150 μm, such that the adhesion of the lamination film to the substrate, such as paper or board in particular, is very good. This is found in that, in an attempt to part the film from the paper or board again, fiber breakage occurs.

In a further embodiment, layer B comprises 0.05% to 0.3% by weight, based on the total weight of layer B, of a lubricant or demolding agent such as erucamide or preferably stearamide. The lubricant or demolding agent, especially in association with antiblocking agents, prevents blocking on unrolling of the polyester film, which can be used for lamination in a further step. The laminate having a polyester-comprising layer enables any later deformation of the laminate. This embodiment has very good compatibility with layer A up to layer thicknesses of 50 μm, in the case of stearamide even up to 80 μm, such that the adhesion of the lamination film to the substrate, such as paper or board in particular, is very good. This is found in that, in an attempt to part the film from the paper or board again, fiber breakage occurs. If, by contrast, lubricants or demolding agents such as behenamide or erucamide or stearamide are used in concentrations higher than 0.3% by weight in layer B, poor compatibility with layer A is observed. In the event that it comprises stearamide, layer B preferably has a thickness of 5 to 50 μm, preferably 10 to 50 μm. In the event that layer B comprises erucamide, the layer thickness is preferably in the range from 5 to 80 μm, more preferably in the range from 5 to 50 μm, more preferably in the range from 10 to 50 μm.

The inventive compound of components i to v may also comprise further additives known to those skilled in the art. Examples include the additives customary in the plastics industry such as stabilizers; nucleating agents such as the already abovementioned mineral fillers b3 or else crystalline polylactic acid; release agents such as stearates (especially calcium stearate); plasticizers, for example citric esters (especially acetyl tributyl citrate), glyceryl esters such as triacetylglycerol or ethylene glycol derivatives, surfactants such as polysorbates, palmitates or laurates; antistats, UV absorbers; UV stabilizers; antifogging agents, pigments or preferably biodegradable Sicoversal® dyes from BASF SE. The additives are used in concentrations of 0 to 2% by weight, especially 0.1 to 2% by weight, based on layer B. Plasticizers may be present in layer B of the invention at 0.1% to 10% by weight. For flexible packaging in the food and drink industry, high demands are made on the oxygen barrier and aroma barrier. An advantageous layer structure has been found here to be one with an additional barrier layer C. An example of a suitable layer structure is A/B/C/B where layers A and B are as defined above and layer C is a barrier layer consisting of polyglycolic acid (PGA), ethylene-vinyl alcohol (EVOH) or preferably polyvinylalcohol (PVOH).

The oxygen barrier layer C typically has a layer thickness of 2 to 10 μm and preferably consists of polyvinylalcohol. An example of a suitable PVOH is G-Polymer from Mitsubishi Chemicals, especially G-Polymer BVE8049. Since the PVOH adheres inadequately to the biopolymer layer B, the barrier layer is preferably composed of the individual layers C′/C/C′ where layer C′ is an adhesion promoter layer. An example of a suitable adhesion promoter is the copolymer BTR-8002P from Mitsubishi Chemicals. The adhesion promoter layer typically has a layer thickness of 2 to 6 μm. The lamination film in these cases has the overall layer structure A/B/C′/C/C′/B or B′, for example.

A further suitable layer structure is A/B/C/B′ where layers A, B and C are as defined above and layer B′ has a layer thickness of 10 to 100 μm and, in addition to the components mentioned for layer B, as lubricant or demolding agent, comprises 0.1% to 0.5% by weight, preferably 0.2% to 0.5% by weight, based on the total weight of layer B′ of erucamide, stearamide or preferably behenamide.

The lamination film of the invention is used for composite film lamination of a substrate selected from the group of biodegradable film, metal foil, metallized foil, cellophane or preferably paper products.

The term “paper products” in the context of the present invention encompasses all kinds of paper and board.

Suitable fibers for the production of the paper products mentioned are all kinds in customary use, for example mechanical pulp, bleached and unbleached chemical pulp, paper materials from all annual plants and used paper (including in the form of reject material, either coated or uncoated). The fibers mentioned may be used either on their own or in the form of any mixture thereof to produce the chemical pulps from which the paper products are produced. The term “mechanical pulp” encompasses, for example, woodpulp, thermomechanical pulp (TMP), chemothermomechanical pulp (CTMP), compressed woodpulp, semichemical pulp, chemical high-yield pulp and refiner mechanical pulp (RMP). By way of example, sulfate pulps, sulfite pulps and soda pulps are suitable chemical pulps. Examples of suitable annual plants for production of paper materials are rice, wheat, sugarcane and kenaf.

It is customary to add amounts of 0.01% to 3% by weight, preferably of 0.05% to 1% by weight, of size to the chemical pulps, based in each case on the solids content of the dry paper matter, which may vary depending on the desired degree of sizing of the papers to be modified. The paper may additionally comprise further substances, for example starch, pigments, dyes, optical brighteners, biocides, paper strengtheners, fixatives, defoamers, retention aids and/or dewatering aids.

The composite films produced preferably have the following structure:
i) a paper having a basis weight of 30 to 600 g/m², preferably of 40 to 400 g/m², more preferably of 50 to 150 g/m²,
ii) the lamination film of the invention having a total thickness of 5.5 to 300 μm, preferably of 10 to 150 μm, and with particular preference of 15 to 100 μm.

For the paper layers, it is possible to use a wide variety of different materials, for example white or brown kraftliner, chemical pulp, used paper, corrugated board or screenings.

The total thickness of the paper-film composite is generally between 31 and 1000 g/m². By lamination it is preferably possible to produce a paper-film composite of 80-500 μm, and by extrusion coating it is more preferably possible to produce a paper-film composite of 50-300 μm.

The production of a composite film from the lamination film of the invention and the substrate is preferably effected in multiple steps: first of all, preferably, i) the surface of layer B is activated by corona treatment; ii) an aqueous dispersion of a polyurethane adhesive is applied and dried, and iii) the lamination film thus obtained from claims 1 to 7 is pressed onto the substrate by side A by a suitable roller pressure.

A surface treatment of layer B prior to coating with polymer dispersion A is not absolutely necessary. However, better results can be obtained when the surface of layer B is modified prior to the coating process. It is possible here to use conventional surface treatments, for example corona treatment, to enhance the bonding effect. Corona treatment or other surface treatments are carried out to the extent required for sufficient wettability with the coating material. Corona treatment at about 10 watts per square meter and minute is generally sufficient for this purpose. Alternatively or additionally, it is also possible to use primers or interlayers between layer B and adhesive coating A. The composite films and especially the lamination film may, as mentioned, also include other additional functional layers, for example barrier layers, print layers, color layers or paint layers or protective layers. The position of the functional layers may preferably be on the outside, i.e. on the side of layer B remote from the adhesive-coated side.

Within the composite film of the invention, the substrate (e.g. paper) has protection from mineral oil and other types of oil and from grease and moisture, since the lamination film exerts a corresponding barrier effect. On the other hand, the food or drink products, when composite films are used for food packaging, have protection from the mineral oils and mineral substances present in the used paper, for example, since the lamination film exerts this barrier effect. Since the composite film can additionally be welded to itself and to paper, board, cellophane and metal, it enables the production of, for example, coffee cups, drinks cartons or boxes for frozen products.

The composite film is particularly suitable for production of paper bags for dry foods, e.g. coffee, tea, powdered soup, powdered sauce; for liquids, e.g. cosmetics, cleaning products, drinks; tubular laminates; paper carrier bags, paper laminates and coextrudates for ice cream, confectionery (e.g. chocolate and muesli bars) and paper adhesive tape; paper cups, yoghurt cups; ready meal dishes; wrapped cardboard packaging (cans, drums), wet-resistant boxes for outer packaging (wine bottles, food or drink products); fruit boxes made of coated board; fast food plates; clamshell boxes; drinks cartons and cartons for liquids, such as washing and cleaning products, boxes for frozen products, ice cream packaging (for example ice cream cups, wrapping material), e.g. ice cream cups, wrapping material for conical ice waffles); paper labels; flower pots and plant pots.

It may be advantageous to apply the lamination film to the substrate by the extrusion coating method. The abovementioned aqueous lamination adhesive formulation (polymer dispersion A) is applied as interlayer. The benefit in using the lamination adhesive formulation in the extrusion coating method lies in the possibility of lowering the extrusion temperature. The mild conditions used save energy and provide protection from breakdown of the biodegradable or preferably home-compostable polymer.

Dispersion coatings do not require heating prior to application. The coating technique is comparable to that of hotmelt adhesives where coatings in sheet form are concerned. Belt speeds are very high: up to 3000 m/min. Dispersion coating processes can therefore also be conducted online on paper machines.

In the case of thin layers, it is also possible to apply layer A in the form of hotmelt, to some degree as a special case of the extrusion coating process or dispersion application method. This method is described in Ullmann, TSE Troller-Beschichtung [TSE Troller coating]. The hotmelt is pumped into the die from a reservoir vessel preheated to about 150 to 200° C., by which the material is applied to the surface.

The composite films produced in accordance with the invention are especially suitable for production of flexible packaging, especially for food packaging.

The invention therefore provides for the use of the lamination film described herein for production of composite films that are biodegradable or preferably biodegradable under home composting conditions, and wherein the composite film is part of a home-compostable flexible packaging.

One benefit of the invention is that the lamination film used in accordance with the invention enables good adhesive bonding of different substances to one another, such as substrate and layer B, as a result of which the bonded composite attains high strength. The composite films produced in accordance with the invention additionally have good biodegradability and especially home compostability.

In the context of the present invention, the feature “biodegradable” is fulfilled for a substance or a substance mixture when this substance or the substance mixture has a percentage degree of biodegradation according to DIN EN 13432 of at least 90% after 180 days.

In general, the effect of biodegradability is that the polyester (mixtures) decompose in an appropriate and verifiable timeframe. Degradation can take place enzymatically, hydrolytically, oxidatively, and/or by the action of electromagnetic radiation, for example UV radiation, and is usually brought about predominantly by the action of microorganisms such as bacteria, yeasts, fungi, and algae. Biodegradability is quantifiable, for example, by mixing polyesters with compost and storing them for a certain time. For example, according to DIN EN 13432 (which refers to ISO 14855), CO₂-free air is passed through matured compost during composting and said compost is subjected to a defined temperature program. Biodegradability is here defined via the ratio of the net CO₂ release from the sample (after subtraction of the CO₂ released by the compost without sample) to the maximum CO₂ release from the sample (calculated from the carbon content of the sample) as a percentage degree of biodegradation. Biodegradable polyester (mixtures) generally show clear signs of degradation such as fungus growth and tear and hole formation after just a few days of composting.

Other methods for determining biodegradability are described for example in ASTM D 5338 and ASTM D 6400-4.

The present invention preferably provides lamination films or composite films comprising these lamination films that are biodegradable under home composting conditions (25±5° C.). Home composting conditions mean that the lamination films or composite films are degraded to CO₂ and water to an extent of more than 90% by weight within 360 days.

Home compostability is tested according to Australian standard AS 5810-2010 or French standard NF T 51-800 or ISO 14855-1 (2012) “Determination of the ultimate aerobic biodegradability of plastic materials under controlled composting conditions—Method by analysis of evolved carbon dioxide” at ambient temperature (28±2° C.), in order to simulate home composting conditions rather than the temperature of 58° C. described in ISO standard ISO 14855-1 (2012).

### PROPERTIES

Glass transition temperatures were determined by differential scanning calorimetry (ASTM D 3418-08, midpoint temperature of the second heating curve, heating rate 20 K/min).

Melting points and enthalpy of fusion are determined to DIN 53765 (1994) (melting point=peak temperature) by heating at 20 K/min after heating the polyurethane films to 120° C., cooling at 20 K/min to 23° C., heat treatment at that temperature for 20 hours.

### Starting Materials

### Components of Layer A)

a-1) Epotal® Eco 3702 from BASF SE, aqueous polyurethane dispersion (see PCT/EP2021/054570)
a-2) Epotal® P 100 eco from BASF SE, aqueous polyurethane dispersion (see WO 2010/034712)

### Components of Layer B)

### Component b1):

b1-1) polybutylene adipate-co-terephthalate: ecoflex® F C1200 from BASF SE (MVR at 2.5-4.5 cm³/10 min (190° C., 2.16 kg))
b1-2) polybutylene sebacate-co-terephthalate: ecoflex® FS C2200 from BASF SE (MVR at 3-5 cm³/10 min (190° C., 5 kg))

### Component b2):

b2-1) polylactic acid: (PLA) Ingeo® 4044 D from NatureWorks (MVR 1.5-3.5 cm³/10 min (190° C., 2.16 kg))

### Component b3):

b3-1) Plustalc H05C from Elementis
b3-2) calcium carbonate from Omya

### Component b4):

b4-1) erucamide: Crodamide™ ER from Croda International Plc
b4-2) stearamide: Crodamide SRV from Croda
b4-3) behenamide: Crodamide BR from Croda

### Component b5):

b5-1) Joncryl® ADR 4468, glycidyl methacrylate from BASF SE

### Components of Layer C)

c-1 (C′) BTR-8002P adhesion promoter from Mitsubishi Chemicals
c-2 G-Polymer BVE8049 PvOH from Mitsubishi Chemicals

### Compounding of Layer B

The compounds shown in table 1 were manufactured in a Coperion MC 40 extruder. Exit temperatures were set to 250° C. The extrudate was subsequently pelletized underwater. After pelletization, the pellets were dried at 60° C.

### DESCRIPTION OF THE BLOWN FILM PLANTS FOR FILM PRODUCTION

The blown film plant consisted of a single-screw extruder with diameter 30 mm and length 25D, a spiral mandrel distributor with diameter 80 mm and a die gap of 0.8 mm. The blow-ratio was typically 3.5, which results in a laid-flat film hose width of about 440 mm.

The multilayer films were formed by coextrusion.

TABLE 1
Composition of layer B

| | b1-1 | b1-2 | b2-1 | b3-1 | b3-2 | b4-1 | b4-2 | b4-3 | b5-1 |
|---|---|---|---|---|---|---|---|---|---|
| | % | % | % | % | % | % | % | % | % |
| | by wt. | by wt. | by wt. | by wt. | by wt. | by wt. | by wt. | by wt. | by wt. |
| I (V) | | 71.9 | 8 | 6 | 14 | | | | 0.1 |
| II | 88.4 | | 9 | | 2.4 | 0.1 | | | 0.1 |
| III | | 75.8 | 9 | 15 | | 0.2 | | | |
| IV | 90.7 | | 9 | | | | 0.2 | | 0.1 |
| V | 87.7 | | 9 | 3 | | | 0.2 | | 0.1 |
| VI | | 75.8 | 9 | 15 | | | 0.2 | | |
| VII | | 75.7 | 9 | 15 | | | 0.3 | | |
| VIII (V) | | 75.8 | 9 | 15 | | | | 0.2 | |
| IX | | 75.8 | 9 | 15 | | | 0.2 | | |
| X (V) | | 75.6 | 9 | 15 | | | 0.4 | | |
| XI | | 76 | 9 | 15 | | | | | |

In tables 1 and 2, V means comparative example

TABLE 2
Composition of the lamination film

| | A | B | | C′ | C | C′ | B/B′ | |
|---|---|---|---|---|---|---|---|---|
| Example | 4 μm | μm | Tab. 1 | 4 μm | 8 μm | 4 μm | 17 μm | Adhesion* |
| V-1 | a-1) | 17 | XI | | | | | + |
| V-2 | a-1) | 100 | XI | | | | | + |
| V-3 | a-1) | 200 | XI | | | | | − |
| V-4 | a-1) | 17 | XI | c-1 | c-2 | c-1 | VIII | + |
| V-5 | a-1) | 12 | I | | | | | + |
| 6 | a-1) | 12 | III | | | | | + |
| 7 | a-1) | 12 | IV | | | | | + |
| 8 | a-1) | 12 | V | | | | | + |
| V-9 | a-1) | 60 | V | | | | | −/+ |
| V-10 | a-1) | 10 | VIII | | | | | − |
| 11 | a-1) | 17 | IX | | | | | + |
| 12 | a-1) | 17 | IX | c-1 | c-2 | c-1 | V | + |
| V-13 | a-1) | 17 | X | | | | | − |
| 14 | a-1) | 17 | VII | | | | | + |
| 15 | a-1) | 30 | VI | | | | | + |
| V-16 | a-1) | 150 | VI | | | | | − |
| V-17 | a-1) | 50 | VIII | | | | | − |
| 18 | a-1) | 50 | III | | | | | + |
| V-19 | a-1) | 10 | VIII | | | | | − |

*Adhesion of the lamination film to the substrate (paper) was ascertained as follows: The base film B was fixed on the laboratory coating unit with the corona-pretreated side upward and the adhesive under test was knife-coated directly onto the film. The adhesive A was dried for 2 minutes with a hot air blower and then the laminating film is placed on with a manual roller and pressed in the roller laminating station at 70° C. with a roll speed of 5 m/minute and a laminating pressure of 6.5 bar onto a paper of different thickness from 50 gsm to 130 gsm. Thereafter, using a cutting stencil, the laminate was cut into strips of width 15 millimeters and subjected to various storage cycles. After storage, the laminate strip was pulled apart on the tensile tester, and the force required for the purpose was recorded. The test took place on a tensile tester at an angle of 90 degrees and a removal speed of 100 mm/min. The test strip was opened up on one side, with one of the resultant loose ends being clamped into the upper jaw and the other into the lower jaw of the tensile tester, and the test was commenced.
The rating (+) given in the last column of table 2 means: fibers pulled out at a force of >0.6 N/15 mm.
The rating (−) given in the last column means: no fibers pulled out at a force of >0.6 N/15 mm.

The tests reported in table 2 show that lamination films comprising no demolding agent b4 in the layer have very good adhesion on the paper substrate up to a total layer thickness of the lamination film of about 150 μm. If erucamide b4-1 or stearamide b4-2 is used as demolding agent up to a concentration of 0.3% by weight, it is possible to achieve very good adhesion on the paper substrate up to a total layer thickness of the lamination films of about 50-60 μm. If, by contrast, behenamide b4-3 is used as demolding agent in a concentration of 0.2% to 0.3% by weight or stearic acid in a concentration of 0.4% by weight, adhesion on the paper is already inadequate in the case of a layer thickness of the lamination film of 10 or 17 μm.

### Home Composting Test

Home compostability is tested according to French standard NF T 51-800 or ISO 14855-1(2012) “Determination of the ultimate aerobic biodegradability of plastic materials under controlled composting conditions-Method by analysis of evolved carbon dioxide” at ambient temperature (28±2° C.) in order to simulate home composting conditions rather than the described temperature of 58° C.

Home compostability of the lamination films of thickness of about 60 μm from examples 4 and 12 was examined under the abovementioned conditions, and complete (>90%) degradation of the films was observed after 116 days and 157 days respectively. These films thus meet the criterion of home compostability under Australian standard AS 5810-2010 and ISO 14855-1 (2012). It can therefore be assumed that the thinner films having the A/B layer structure and a composition of layer B: I, V to XI (see table 1) are likewise home-compostable.

1.-9. (canceled)

10. A biodegradable lamination film having the A/B layer structure, where layer A of thickness 0.5 to 7 μm comprises a polyurethane or acrylate adhesive; and layer B comprises an aliphatic polyester and/or aliphatic-aromatic polyester and 0.05% to 0.3% by weight of a lubricant selected from erucamide and stearamide, where the aliphatic-aromatic polyester is of the following composition:
b1-i) 30 to 70 mol %, based on components b1-i and b1-ii, of an aliphatic C₆-C₁₈ dicarboxylic acid;
b1-ii) 30 to 70 mol %, based on components b1-i and b1-ii, of an aromatic dicarboxylic acid;
b1-iii) 98 to 100 mol %, based on components b1-i and b1-ii, of propane-1,3-diol or butane-1,4-diol;
b1-iv) 0% to 2% by weight, based on components b1-i to b1-iii, of a chain extender and/or branching agent,
where layer B comprising erucamide has a layer thickness of 5 to 80 μm,
and layer B comprising stearamide has a layer thickness of 5 to 50 μm.

11. The lamination film according to claim 10, wherein layer B is composed of:
b1) 60% to 99.95% by weight of an aliphatic-aromatic polyester selected from the group consisting of: polybutylene adipate-co-terephthalate, polybutylene azelate-co-terephthalate and polybutylene sebacate-co-terephthalate;
b2) 0% to 15% by weight of a polyhydroxyalkanoate;
b3) 0% to 25% by weight of a mineral filler;
b4) 0.05% to 0.3% by weight of a lubricant selected from erucamide and stearamide.

12. The lamination film according to claim 10, wherein layer A is formed from an aqueous polyurethane dispersion, where at least 60% by weight of the polyurethane is composed of:
a1) at least one diisocyanate;
a2) at least one polyesterol;
a3) at least one bifunctional carboxylic acid selected from the group of dihydroxycarboxylic acid and diaminocarboxylic acid; and
where the glass transition temperature of the polyurethane is below 20° C. or the melting point of the polyurethane is not above 20° C. and has an enthalpy of fusion below 10 J/g.

13. The lamination film according to claim 10, wherein layer B has a layer thickness of 10 to 50 μm and comprises 0.05% to 0.3% by weight, based on the total weight of layer B, of erucamide.

14. A biodegradable lamination film having the A/B/C/B layer structure, wherein layers A and B have the definition given in claim 10 and layer C is an oxygen or aroma barrier layer consisting of polyglycolic acid or ethylene-vinyl alcohol

15. The lamination film according to claim 14, wherein the barrier layer consists of the individual layers C′/C/C′ and layer C is composed of polyvinylalcohol and C′ is an adhesion promoter layer.

16. A biodegradable lamination film having the A/B/C/B′ layer structure, wherein layers A, B and B′ have the definition given in claim 10 and layer B′ has a layer thickness of 10 to 100 μm and comprises 0.2% to 0.5% by weight, based on the total weight of layer B′, of erucamide, stearamide, or behenamide.

17. A method for composite film lamination of a substrate selected from the group of biodegradable film, metal foil, metallized foil, cellophane, paper, or board, the method comprising utilizing the lamination films according to claim 10.

18. A process for producing a composite film, wherein i) the surface of layer B is activated by corona treatment; ii) an aqueous dispersion of a polyurethane adhesive is applied and dried, and iii) the lamination film thus obtained from claim 10 is pressed onto the substrate by side A by a suitable roller pressure.
